(19) United States
(12) Patent Application Publication
(10) Pub. No.: US 2006/0234109 A1
(43) Pub. Date: Oct. 19, 2006

(54) Composite flow field plates and process of molding the same

(76) Inventors: Reena L. Datta, Rochester, NY (US); Michael K. Budinski, Pittsford, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/106,065

(22) Filed: Apr. 14, 2005

(51) Int. Cl. H01M 8/02; B29C 45/14

(52) U.S. Cl. 429/38; 264/259

(57) ABSTRACT

An improved flowfield plate design and a process for fabricating such a plate is provided. In accordance with one embodiment of the present invention, a process of fabricating a bipolar plate is provided. The bipolar plate comprises a flowfield defined between opposite, electrically conductive sides of the bipolar plate. According to the process, a flowfield skeleton is provided. The flowfield skeleton comprises a sacrificial core overplated by a hydrogen permeation barrier layer. An electrically conductive polymeric composite material is molded about the flowfield skeleton to define the opposite sides of the bipolar plate. The molded polymeric composite material is cured such that the hydrogen permeation barrier layer adheres to the composite material and the sacrificial core melts away from the composite material and the barrier layer to define a flowfield cavity between the opposite sides of the bipolar plate.

### BACKGROUND OF THE INVENTION

The present invention relates to electrochemical conversion cells, commonly referred to as fuel cells, which produce electrical energy through oxidation and reduction of first and second reactants, typically hydrogen and oxygen. A typical cell comprises a polymer membrane (e.g., a proton exchange membrane) that is positioned between a pair of gas diffusion media layers and catalyst layers. A cathode plate and an anode plate are positioned at the outermost sides adjacent the gas diffusion media layers, and the preceding components are tightly compressed to form the cell unit.

The voltage provided by a single cell unit is typically too small for useful application. Accordingly, a plurality of cells are typically arranged and connected consecutively in a “stack” to increase the electrical output of the electrochemical conversion assembly or fuel cell. In this arrangement, two adjacent cell units can share a common polar plate, which serves as the anode and the cathode for the two adjacent cell units it connects in series. Such a plate is commonly referred to as a bipolar plate and includes a flow field defined therein to enhance the delivery of reactants and coolant to the associated cells.

Bipolar plates for fuel cells are typically required to be electrochemically stable, electrically conductive, and inexpensive. Polymeric bipolar plates, also commonly referred to as composite plates because the polymer typically includes conductive filler materials, have attracted significant attention as a viable alternative to conventional metallic bi-polar plates because they fulfill these criteria. However, composite plates are typically more permeable to hydrogen than metallic plates and this can lead to significant losses in cell performance and efficiency. More specifically, hydrogen permeation through composite plates can result in the presence of hydrogen in the coolant passages in the flow field of the plate. Accordingly, there is a recognized need for improvements in bipolar plate design for fuel cell stacks, particularly in the context of composite bipolar plates.

### BRIEF SUMMARY OF THE INVENTION

An improved flowfield plate design and a process for fabricating such a plate is provided. In accordance with one embodiment of the present invention, a process of fabricating a bipolar plate is provided. The bipolar plate comprises a flowfield defined between opposite, electrically conductive sides of the bipolar plate. According to the process, a flowfield skeleton is provided. The flowfield skeleton comprises a sacrificial core overplated by a hydrogen permeation barrier layer. An electrically conductive polymeric composite material is molded about the flowfield skeleton to define the opposite sides of the bipolar plate. The molded polymeric composite material is cured such that the hydrogen permeation barrier layer adheres to the composite material and the sacrificial core melts away from the composite material and the barrier layer to define a flowfield cavity between the opposite sides of the bipolar plate. The melted sacrificial core is removed from the flowfield cavity.

In accordance with another embodiment of the present invention, a process of fabricating a bipolar plate is provided where the electrically conductive polymeric composite material is molded about the sacrificial core and a portion of the non-conductive fluid header of the flowfield skeleton to couple the non-conductive fluid header to the composite material and define the opposite sides of the bipolar plate.

In accordance with yet another embodiment of the present invention, a device is provided comprising a bi-polar plate. The bipolar plate comprises a polymeric composite flowfield portion and a non-conductive fluid header portion coupled to the flowfield portion. The flowfield portion is of unitary construction and defines opposite, electrically conductive sides and a flowfield between the opposite, electrically conductive sides of the plate. The opposite, electrically conductive sides of the flowfield portion define an interior face exposed to the flowfield. The interior face of the flowfield portion is overplated, at least in part, by a hydrogen permeation barrier layer. The flowfield portion bounds at least a portion of the non-conductive fluid header portion such that the header is held by the flowfield portion.

Accordingly, it is an object of the present invention to provide an improved bipolar plate design and a process for fabricating a bipolar plate. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is an illustration of a bipolar plate according to one embodiment of the present invention;

FIG. 2 is an illustration of a process for fabricating a bipolar plate according to one embodiment of the present invention;

FIG. 3 is a cross-sectional illustration of a portion of a bipolar plate according to one embodiment of the present invention; and

FIG. 4 is an illustration of a vehicle powered by a fuel cell stack incorporating a bipolar plate according to the present invention.

### DETAILED DESCRIPTION

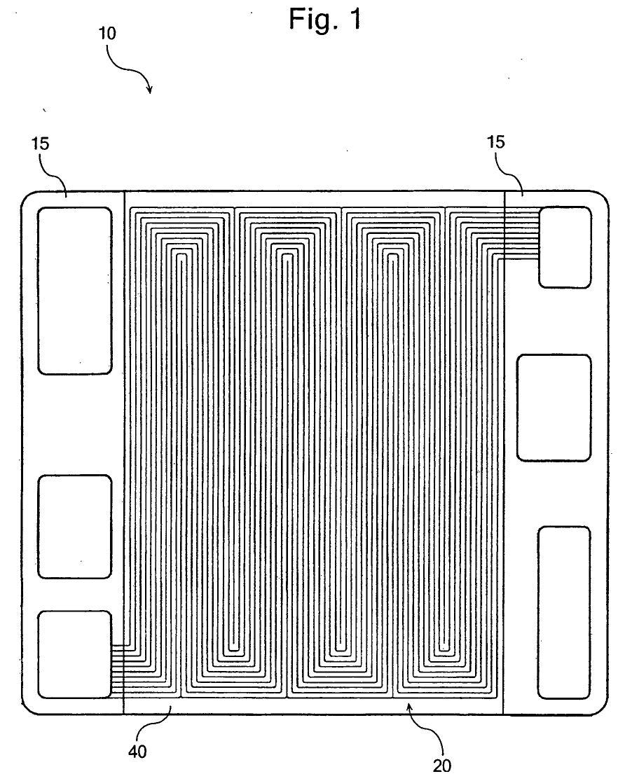

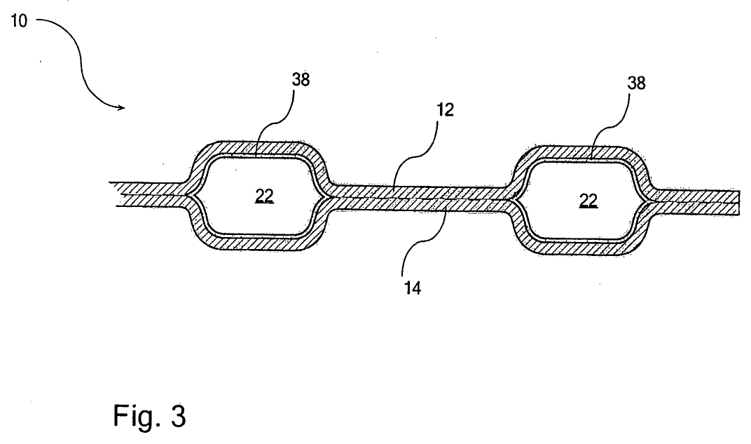

Referring collectively to FIGS. 1-3, a process of fabricating a bipolar plate 10 and a bipolar plate produced thereby are illustrated in detail. Referring initially to FIG. 1, a bipolar plate 10 according to the present invention typically comprises a flowfield portion 20 and fluid header portions 15 coupled to the flowfield portion 20. As is illustrated in FIG. 3, the flowfield portion 20 includes flowfield channels 22 defined between opposite, electrically conductive sides 12, 14 of the bipolar plate 10. As will be described in further detail below, because of the manner in which the bipolar plate 10 is fabricated, there is typically no discernable boundary between the two opposite, electrically conductive sides 12, 14 of the bipolar plate 10.

The flowfield portion 20 comprises an electrically conductive composite material comprising, for example, a polymeric material including conductive filler, e.g., graphite, carbon fibers, etc., provided in sufficient quantity to render the flowfield portion 20 electrically conductive. In contrast, the fluid header portions 15 may be constructed of a non-conductive material to help eliminate the corrosion centers caused by galvanic cells set up by shunt currents in fuel cell stacks employing bipolar plates.

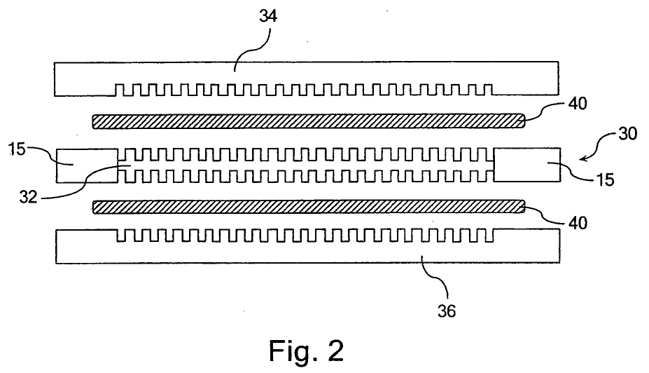

Referring now to FIG. 2, in a process for fabricating a bipolar plate according to the present invention, a suitable profiled flowfield skeleton 30 is provided between upper and lower profiled molds 34, 36. The skeleton 30 comprises non-sacrificial fluid header portions 15 and a sacrificial core 32. The core 32, which is profiled to define suitable flowfield channels 22 in the bipolar plate 10, is referred to herein as “sacrificial” because it does not form part of the final bipolar plate 10. In contrast, the fluid header portions 15 are not sacrificial and form part of the final plate construction. It is also noted that the components of FIG. 2 are not illustrated to scale, particularly the profiled portions of the core 32 and the upper and lower molds 34, 36.

An electrically conductive polymeric composite material 40 is molded about the flowfield skeleton 30 using the profiled molds 34, 36. The electrically conductive polymeric composite material 40 can also be molded about a portion of the non-conductive fluid headers 15 of the flowfield skeleton 30 to couple the headers 15 mechanically to the remainder of the bipolar plate 10 and to form an interface with the remainder of the bipolar plate that is sealed against flowfield fluid leakage. As will be appreciated by those practicing the present invention, the non-conductive fluid header portions 15 should be characterized by a melting point that exceeds the melting point of the sacrificial core 32.

The electrically conductive polymeric composite material 40 used to form the bi-polar plates according to the present invention may comprise any suitable polymeric material. For example, and not by way of limitation, the composite material 40 may comprise a suitable powder molding compound or a thermoset or thermoplastic sheet molding compound with an electrically conductive filler. Additional examples include vinyl esters, phenolics, epoxies, etc.

The molds 34, 36 can also be referred to as anode and cathode flowfield molds 34, 36 because they define the opposite sides 12, 14 of the bipolar plate 10. The particular patterns defined by the anode and cathode flowfield molds 34, 36 and the flowfield skeleton 30 are beyond the scope of the present invention and, as such, are merely illustrated schematically in FIG. 2.

The molded polymeric composite material 40 is then cured so as to melt the sacrificial core 32 away from the composite material 40 to define a flowfield cavity between the opposite sides 12, 14 of the bipolar plate 10. In one embodiment of the present invention, the sacrificial core 32 is overplated by a hydrogen permeation barrier layer. Referring specifically to FIG. 3, the hydrogen permeation barrier layer 38 adheres to the composite material 40 as the core 32 melts away during curing. The barrier layer 38 can be any suitable material that is more resistant to hydrogen permeation than the composite material 40. For example, and not by way of limitation, the barrier layer 38 can be a metal selected from Ni, Zn, Sn, Cu, Cr, and combinations thereof. As will be appreciated by those practicing the present invention, the hydrogen permeation barrier layer 38 should comprise a material characterized by a melting point that exceeds the melting point of the sacrificial core 32.

The sacrificial core 32 is characterized by a melting point that falls within a temperature range that is above a temperature at which the electrically conductive polymeric composite material 40 is molded about the flowfield skeleton 30 and below a temperature at which the polymeric composite material 40 is cured or post-cured. The sacrificial core may comprise any of a variety of suitable materials. For example, and not by way of limitation, the sacrificial core 32 may be formed of a material selected from fusible alloys, waxes, and combinations thereof.

The melted sacrificial core can be removed from the flowfield cavity during the curing step or following the curing step by, for example, purging the flowfield with a suitable fluid, by evacuating the flowfield, or by any other suitable means. Additionally, the polymeric composite material can be cured using hardware that is configured to remove the melted core and perform diagnostic processes (e.g., pressure drop testing, leak testing, etc.) on the bipolar plate assembly.

A bipolar plate 10 according to one embodiment of the present invention comprises a polymeric composite flowfield portion 20 and a non-conductive fluid header portion 15 coupled to the flowfield portion 20. The flowfield portion 20 is of unitary construction and defines opposite, electrically conductive sides 12, 14 and a flowfield between the opposite, electrically conductive sides 12, 14. As is illustrated in FIG. 3, the opposite, electrically conductive sides 12, 14 of the flowfield portion define an interior face exposed to flowfield channels 22 that collectively form the flowfield of the flowfield portion 20. The interior face of the flowfield portion 20 is overplated, at least in part, by the hydrogen permeation barrier layer 38. In addition, the flowfield portion 20 bounds a portion of the non-conductive fluid headers 15 to an extent sufficient to ensure that the headers 15 are held by the molded flowfield portion 20.

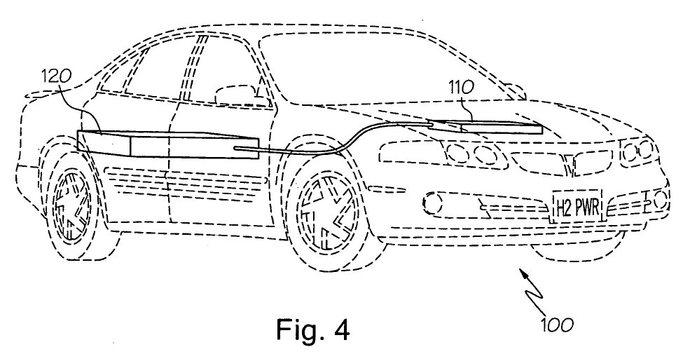

A variety of devices may incorporate one or more bipolar plates 10 according to the present invention. Specifically, and by way of illustration, not limitation, a device according to the present invention may comprise a fuel cell stack incorporating a plurality of bipolar plates 10. Further, a device according to the present invention may comprise a stand alone power generation unit including a plurality of fuel cell stacks or, referring to FIG. 4, a vehicle 100 powered by one or more fuel cell stacks 110. Specifically, fuel from a fuel storage unit 120 may be directed to a fuel cell assembly or stack 110 configured to convert fuel, e.g., H₂, into electricity. The electricity generated is used as a motive power supply for the vehicle 100 where the electricity is converted to torque and vehicle translational motion. Although the vehicle 100 shown in FIG. 4 is a passenger automobile, it is contemplated that the vehicle 100 can be any vehicle now known or later developed that is capable of being powered or propelled by a fuel cell system, such as, for example, automobiles (i.e., car, light- or heavy-duty truck, or tractor trailer), farm equipment, aircraft, watercraft, railroad engines, etc.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A process of fabricating a bipolar plate, said bipolar plate comprising a flowfield defined between opposite, electrically conductive sides of said bipolar plate, said process comprising:
providing a flowfield skeleton, wherein said flowfield skeleton comprises a sacrificial core overplated by a hydrogen permeation barrier layer;
molding an electrically conductive polymeric composite material about said flowfield skeleton to define said opposite sides of said bipolar plate;
curing said molded polymeric composite material such that said hydrogen permeation barrier layer adheres to said composite material and said sacrificial core melts away from said composite material and said barrier layer to define a flowfield cavity between said opposite sides of said bipolar plate; and
removing said melted sacrificial core from said flowfield cavity.

2. A process as claimed in claim 1 wherein said sacrificial core is characterized by a melting point falling within temperature range above a temperature at which said electrically conductive polymeric composite material is molded about said flowfield skeleton and below a temperature at which said polymeric composite material is cured or post-cured.

3. A process as claimed in claim 1 wherein said sacrificial core comprises a material selected from fusible alloys, waxes, and combinations thereof.

4. A process as claimed in claim 1 wherein said hydrogen permeation barrier layer comprises a material characterized by a resistance to hydrogen permeation exceeding that of said polymeric composite material by a substantial amount.

5. A process as claimed in claim 1 wherein said hydrogen permeation barrier layer comprises a metal.

6. A process as claimed in claim 1 wherein said hydrogen permeation barrier layer comprises a material selected from Ni, Zn, Sn, Cu, Cr, and combinations thereof.

7. A process as claimed in claim 1 wherein said hydrogen permeation barrier layer comprises a material characterized by a melting point exceeding that of said sacrificial core.

8. A process as claimed in claim 1 wherein said electrically conductive polymeric composite material is molded about a portion of a fluid header of said flowfield skeleton to couple said fluid header to said composite material.

9. A process as claimed in claim 8 wherein said fluid header is a non-conductive fluid header.

10. A process as claimed in claim 1 wherein said fluid header is characterized by a melting point exceeding that of said sacrificial core.

11. A process as claimed in claim 1 wherein said electrically conductive polymeric composite material comprises a powder molding comound or a thermoset or thermoplastic sheet molding compound.

12. A process as claimed in claim 1 wherein said electrically conductive polymeric composite material comprises a polymer and an electrically conductive filler.

13. A process as claimed in claim 1 wherein said polymeric composite material is cured using hardware configured to remove said melted core and perform diagnostic processes on said bipolar plate assembly.

14. A process as claimed in claim 13 wherein said diagnostic processes comprise pressure drop testing, leak testing, and combinations thereof.

15. A process of fabricating a bipolar plate, said bipolar plate comprising a flowfield defined between opposite, electrically conductive sides of said bipolar plate, and a non-conductive fluid header portion coupled to said electrically conductive sides of said bipolar plate said process comprising:
providing a flowfield skeleton, wherein said flowfield skeleton comprises a sacrificial core and a non-conductive fluid header;
molding an electrically conductive polymeric composite material about said sacrificial core and a portion of said non-conductive fluid header of said flowfield skeleton to couple said non-conductive fluid header to said composite material and define said opposite sides of said bipolar plate;
curing said molded polymeric composite material such that said sacrificial core melts away from said composite material to define a flowfield cavity between said opposite sides of said bipolar plate; and
removing said melted sacrificial core from said flowfield cavity.

16. A process as claimed in claim 15 wherein said flowfield skeleton comprises a sacrificial core overplated by a hydrogen permeation barrier layer.

17. A device comprising a bi-polar plate, said bipolar plate comprising a polymeric composite flowfield portion and a non-conductive fluid header portion coupled to said flowfield portion, wherein:
said flowfield portion is of unitary construction and defines opposite, electrically conductive sides and a flowfield between said opposite, electrically conductive sides;
said opposite, electrically conductive sides of said flowfield portion define an interior face exposed to said flowfield;
said interior face of said flowfield portion is overplated, at least in part, by a hydrogen permeation barrier layer; and
said flowfield portion bounds at least a portion of said non-conductive fluid header portion such that said header is held by said flowfield portion.

18. A device as claimed in claim 17 wherein said device further comprises a fuel cell stack incorporating a plurality of said bipolar plates.

19. A device as claimed in claim 18 wherein said device further comprises a plurality of said fuel cell stacks and is configured as a stand-alone source of electrical power.

20. A device as claimed in claim 18 wherein said device further comprises a vehicle powered by said fuel cell stack.
